(19) United States
(12) Patent Application Publication
(10) Pub. No.: US 2014/0222634 A1
(43) Pub. Date: Aug. 7, 2014

(54) Method for Environmental Control and Monitoring

(71) Applicant: Innovaci Inc., New Brunswick, NJ (US)

(72) Inventors: Michael Gordon, Warren, NJ (US); J. Henry Scott, Warren, NJ (US); Edward J. Laganis, Hoboken, NJ (US); James M. Judge, Bushkill, PA (US); Keith Armonaitis, Rockaway, NJ (US)

(73) Assignee: Innovaci Inc., New Brunswick, NJ (US)

(21) Appl. No.: 14/250,540

(22) Filed: Apr. 11, 2014

Related U.S. Application Data
(63) Continuation-in-part of application No. 13/566,776, filed on Aug. 3, 2012.
(60) Provisional application No. 61/514,675, filed on Aug. 3, 2011.

(51) Int. Cl. G06Q 20/14; G05D 23/19

(52) U.S. Cl. CPC G06Q 20/145; G05D 23/1917
USPC 705/34

(57) ABSTRACT

An environmental control and monitoring method is provided. An electronic communication including a selection of a climate control operational mode to modify an environment within a particular designated area is received from one of a plurality of environmental control and monitoring devices via a network, wherein each of the plurality of environmental control and monitoring devices include one or more climate control subsystems for modifying an environment within a designated area. The selection of the climate control operational mode is associated with a climate control parameter and the one of the plurality of environmental control and monitoring devices. An operation of a particular climate control subsystem of the one of the plurality of environmental control and monitoring devices is initiated to modify the environment within the particular designated area based on the climate control parameter. A usage parameter based on the operation of the particular climate control subsystem is received via the network. A billing message associated with a user is generated based on the usage parameter, and the billing message is transmitted to a billing system, wherein the billing message results in a charge to an account of the user.

### RELATED APPLICATIONS

This application is a continuation-in-part of U.S. patent application Ser. No. 13/566,776, filed Aug. 3, 2012, the disclosure of which is herein incorporated by reference in its entirety.

### TECHNICAL FIELD

The present disclosure is generally directed to device management, and more specifically to managing networked environmental control devices.

### BACKGROUND

Environmental control is useful for creating comfortable indoor environments. Environmental control may be employed in a home, or in a commercial setting such as a hotel room, office cubicle or cruise ship stateroom. A variety of devices such as air purifiers, humidifiers, and fragrance diffusers may be employed in an environmental control system, and data related to the usage of these devices may be useful for optimizing environmental control.

Environmental control may also include monitoring user actions to determine what types of relevant user actions are taken within a monitored environment, and when such actions are performed. Data related to user actions, in combination with data related to the usage of various devices, may be employed to further optimize environmental control. Therefore, it would be advantageous to manage data obtained from various sources to implement more effective environmental control and monitoring systems.

### SUMMARY

Methods, apparatuses, and computer readable media for environmental control and monitoring are provided. In accordance with an embodiment, an electronic communication including a selection of a climate control operational mode to modify an environment within a particular designated area is received from one of a plurality of environmental control and monitoring devices via a network, wherein each of the plurality of environmental control and monitoring devices include one or more climate control subsystems for modifying an environment within a designated area. The selection of the climate control operational mode is associated with a climate control parameter and the one of the plurality of environmental control and monitoring devices. An operation of a particular climate control subsystem of the one of the plurality of environmental control and monitoring devices is initiated to modify the environment within the particular designated area based on the climate control parameter. A usage parameter based on the operation of the particular climate control subsystem is received via the network. The usage parameter may indicate one of a consumable resource level or a filter status. A billing message associated with a user is generated based on the usage parameter, and the billing message is transmitted to a billing system, wherein the billing message results in a charge to an account of the user. The selection of the climate control operational mode may be received from one of a user device or a remote device controller via the network.

In accordance with an embodiment, the selection of the climate control operational mode may be received from a networked appliance. The networked appliance may include one of a clothes washer, clothes dryer, refrigerator, HVAC unit, air purifier, humidifier or fragrance diffuser, and may be located in one of a hotel room, cruise ship stateroom or office.

In accordance with an embodiment, access may be provided to stored user profiles. The selection of the climate control operational mode may be associated with a stored user profile, and the climate control subsystem may be selected for activation based on the stored user profile.

In accordance with an embodiment, access may be provided to one or more records of previously selected climate control operational modes, and the climate control subsystem may be selected for activation based on one of the previously selected climate control operational modes.

In accordance with an embodiment, one or more of the climate control subsystems may modify the environment within the designated area within a designated range based the climate control parameter.

In accordance with an embodiment, an interface may be initiated between the climate control subsystem and an external device, the external device operable to be activated based on the climate control parameter to modify the environment within the designated area.

These and other advantages of the invention will be apparent to those of ordinary skill in the art by reference to the following detailed description and the accompanying drawings.

### BRIEF DESCRIPTION OF THE DRAWINGS

FIG. 1 is a diagram showing a networked environment for environmental control and monitoring in accordance with an embodiment;

FIG. 2 is a diagram showing a table of diagnostic codes that may be used for environmental control and monitoring in accordance with an embodiment;

FIG. 3 is a diagram showing a web portal interface display for environmental control and monitoring in accordance with an embodiment;

FIG. 4 is another diagram showing a web portal interface display for environmental control and monitoring in accordance with an embodiment;

FIG. 5 is another diagram showing a web portal interface display for environmental control and monitoring in accordance with an embodiment;

FIG. 6 is another diagram showing a web portal interface display for environmental control and monitoring in accordance with an embodiment;

FIG. 7 is a flow diagram for environmental control and monitoring in accordance with an embodiment; and

FIG. 8 is a high-level block diagram of an exemplary computer that may be used for remotely managing an environmental control and monitoring device.

### DETAILED DESCRIPTION

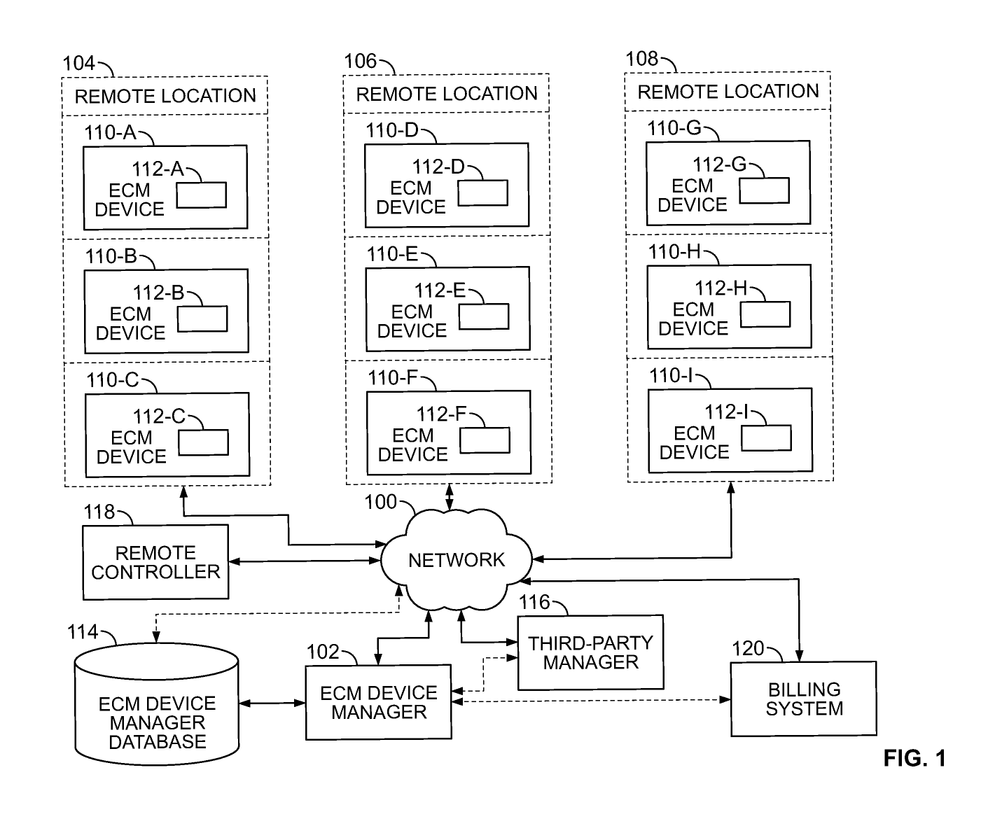

FIG. 1 is a diagram showing a networked environment for environmental control and monitoring in accordance with an embodiment. For example, network 100 may be accessible via an interface of environmental control and monitoring device manager 102 for communication with one or more remote locations, such as remote locations 104, 106 and 108. It should be noted that environmental control and monitoring device manager 102 may communicate with more or fewer remote locations, and that a remote location as referred to herein may be referring to either a physical location or a network location. Moreover, a remote location as referred to herein may be referring to any one of remote locations 104, 106 and 108.

Remote locations 104, 106 and 108 include one or more environmental control and monitoring devices (also referred to herein as “devices”, or singularly, as a “device” or “ECM device”). For example, remote location 104 includes environmental control and monitoring devices 110-A, 110-B and 110-C; remote location 106 includes environmental control and monitoring devices 110-D, 110-E and 110-F; and remote location 108 includes environmental control and monitoring devices 110-G, 110-H and 110-I. It should be noted that an environmental control and monitoring device 110 as referred to herein may be referring to any one of environmental control and monitoring devices 110-A-110-I.

Environmental control and monitoring device manager 102 can be utilized for managing one or more environmental control and monitoring devices 110. In one embodiment, environmental control and monitoring device manager 102 may track usage, monitor maintenance status, receive data and remotely control environmental control and monitoring devices 110. For example, environmental control and monitoring device manager 102 may receive notifications regarding usage or an operating status of one or more environmental control and monitoring devices 110 via network 100. In one embodiment, the one or more environmental control and monitoring devices 110 are network-capable devices used for environmental control and monitoring of indoor areas, such as room heaters and coolers (i.e., HVAC units), air purifiers, humidifiers or fragrance devices. Additional examples of environmental control and monitoring devices 110 may include furnaces, smoke detectors and carbon monoxide detectors. In other embodiments, the environmental control and monitoring devices 110 can include clothes washers, clothes dryers, refrigerators and other appliances that may be used in a home or commercial setting.

An exemplary environmental control and monitoring device 110 includes a networking module 112. For example, environmental control and monitoring device 110-A includes networking module 112-A, environmental control and monitoring device 110-B includes networking module 112-B, environmental control and monitoring device 110-C includes networking module 112-C, etc. It should be noted that networking modules 112 as referred to herein may be referring to any one of networking modules 112-A-112-I.

Networking modules 112 may be cellular data modules that are capable of data communication with environmental control and monitoring device manager 102, such as via network 100. Each networking module 112 may include a printed circuit board (PCB) having a unique identifier that may be associated with a corresponding environmental control and monitoring device 110. For example, the unique identifier may be a network serial number such as a CDMA Mobile Equipment Identifier (MEID). One skilled in the art will note that networking modules 112 and environmental control and monitoring devices 110 may communicate with network 100 using any of a variety of wired (e.g., USB, Firewire, LAN, etc.) or wireless (e.g., CDMA, GSM, Wi-Fi, Bluetooth, etc.) formats. Moreover, networking modules 112 may be external to environmental control and monitoring devices 110, such as within a remote device controller having a wired or wireless connection to network 100 and a short-range protocol connection (e.g., wired, Bluetooth infrared, ear-field communication, infrared, etc.) to communicate with and control environmental control and monitoring device 110.

In one embodiment, a unique identifier may be used for remotely managing an associated environmental control and monitoring device 110. For example, prior to deploying an environmental control and monitoring device 110 in a commercial environment (e.g., in a hotel room), a unique identifier associated with the environmental control and monitoring device 110 may be recorded along with other data, such as the country, city, hotel and room number where the environmental control and monitoring device 110 is located. The unique identifier and other data relating to the environmental control and monitoring device 110 then may be received by environmental control and monitoring device manager 102 and communicated to environmental control and monitoring device manager database 114 (also referred to herein as database 114) for storage either via a direct connection or via network 100. In one embodiment, information may be received and cross-referenced to a unique identifier associated with a particular environmental control and monitoring device 110 by the environmental control and monitoring device manager 102. The environmental control and monitoring device manager 102 may then store the information at database 114 in relation to the particular environmental control and monitoring device 110. Alternatively, environmental control and monitoring device manager 102 may receive and cross-reference information (e.g., associated with a unique identifier) from a third-party manager 116, such as by transmitting a command as part of a check routine to third-party manager 116 either via network 100 or a direct connection.

Information may be stored at database 114 in any of a variety of ways. For example, the information communicated via a stock keeping unit (SKU) scanner or similar handheld device. One skilled in the art will also note that standard technologies can be utilized for entering data into database 114 such as bar code, RFID and 3D video scanning. Alternatively, database 114 may receive unique identifiers and other data relating to the environmental control and monitoring devices 110 directly from network 100, such as by an operation of a web-enabled application operating within network 100.

In certain embodiments, the environmental control and monitoring device manager database 114 will not just store information incoming from each environmental control and monitoring device, but also interact with the environmental control and monitoring devices and be capable of running functions that can purge superfluous data. Such purges can be scheduled so that the database 114 may purge data after a predetermined number of megabytes or at a predetermined time.

One exemplary type of environmental control and monitoring device 110 that can be remotely managed may combine one or more of an air purifier, humidifier or fragrance device. Such a combined function environmental control and monitoring device 110 may include a variety of consumables that must be replaced as a consequence of typical usage. Examples of consumables used by a combined function environmental control and monitoring device 110 may include water, filters, fragrances, de-mineralization tablets, charcoal filters or other filter types that may be used in water/humidification, or any other consumables that typically may be used in environmental control devices. For example, a combined function environmental control and monitoring device 110 may include a humidifier having a water tank rated for an approximate runtime (e.g., 8-10 hours) without a refill. A combined function environmental control and monitoring device 110 also may include a HEPA-type air purifier, which removes airborne particles and contaminants from the room via a filter (e.g., an odor-absorbing carbon media).

In one embodiment, an environmental control and monitoring device 110 may include an interface (e.g., a sensor or a display) for input/output (I/O) interaction with a user and one or more sensors to monitor a user's habits. For example, the environmental control and monitoring device 110 may collect monitoring data based on a user's habits or when a user performs certain tasks (e.g., laundry or cooking). The monitoring data then may be used by the environmental control and monitoring device 110 to generate a behavioral record. The environmental control and monitoring device 110 may then generate a device action (i.e., an electronic notification) for transmission to environmental control and monitoring device manager 102. For example, the environmental control and monitoring device 110 may generate a device action that is based on a behavioral record.

In one embodiment, a device action may include status information regarding an environmental control and monitoring device 110 that is malfunctioning, not responding or reporting an error condition. For example, an environmental control and monitoring device 110 may transmit a device action including a notification that a furnace pilot light is out. A device action also may include a notification that an environmental control and monitoring device 110 is functioning normally or particularly well. Examples of occurrences that may trigger device actions from a device include customer service occurrences, maintenance occurrences, billing procedure occurrences and occurrences relating to marketing information. In one embodiment, occurrences that will trigger device actions may be defined by an organization that is hosting environmental control and monitoring device manager 102.

A device action also may be generated by an environmental control and monitoring device 110 in response to a user input (e.g., for activating a function of the device) or any other user interaction. One example of a user interaction could be opening a lid of a device, such as for monitoring or replenishing a consumable. Alternatively, a user input may be communicated to an environmental control and monitoring device 110 via a remote controller 118, which may be either co-located (e.g., within the environment being managed by the environmental control and monitoring device 110) or at a location remote from the environmental control and monitoring device 110.

In one embodiment, a device action may be associated with one or more user actions monitored by an environmental control and monitoring device 110. For example, user actions including an observed usage pattern of an environmental control and monitoring device 110, an observed wake-up time of a user or times when a user leaves or returns to the location of an environmental control and monitoring device 110 may be monitored, and such information may be included in a device action. Further, a device action may include a record of one or more previous devices actions. As such, a correlation can be made based on the record of previous device actions to determine a management action, as described in detail below.

In another embodiment, a device action may comprise a device code (e.g., identifying a particular device or type of device), and a management action may be based, at least in part, on the device code. For example, one or more device actions may be received from a plurality of environmental control and monitoring devices 110. In such case, a device action may be determined to be associated with a particular environmental control and monitoring device 110 based on a unique identifier (e.g., a serial number or device ID) of the particular environmental control and monitoring device 110. A transmitted management action may then include the unique identifier of the particular environmental control and monitoring device 110. For example, the management action may include a unique identifier to convey a command which causes the particular environmental control and monitoring device 110 to execute an operation.

One or more device actions associated with a particular environmental control and monitoring device 110 also may be stored based on a unique identifier, such as in database 114. Currently received or previously stored device actions then may be displayed in relation to a particular environmental control and monitoring device 110, such as at a user interface of environmental control and monitoring device manager 102. In certain embodiments, the environmental control and monitoring device manager database 114 may store device codes for environmental control and monitoring devices 110 including network location information (e.g., information regarding remote locations 104, 106 or 108). Further, monitoring device manager database 114 may store additional information regarding environmental control and monitoring devices 110, including user identification information related to particular environmental control and monitoring devices 110. As such, environmental control and monitoring device manager 102 may employ the device codes for environmental control and monitoring devices 110 to generate a billing message associated with a user. The billing message, for example, may be based on a usage parameter received from a particular environmental control and monitoring device 110. The environmental control and monitoring device manager 102 may then transmit the billing message to billing system 120, where the billing message can result in a charge to an account of the user.

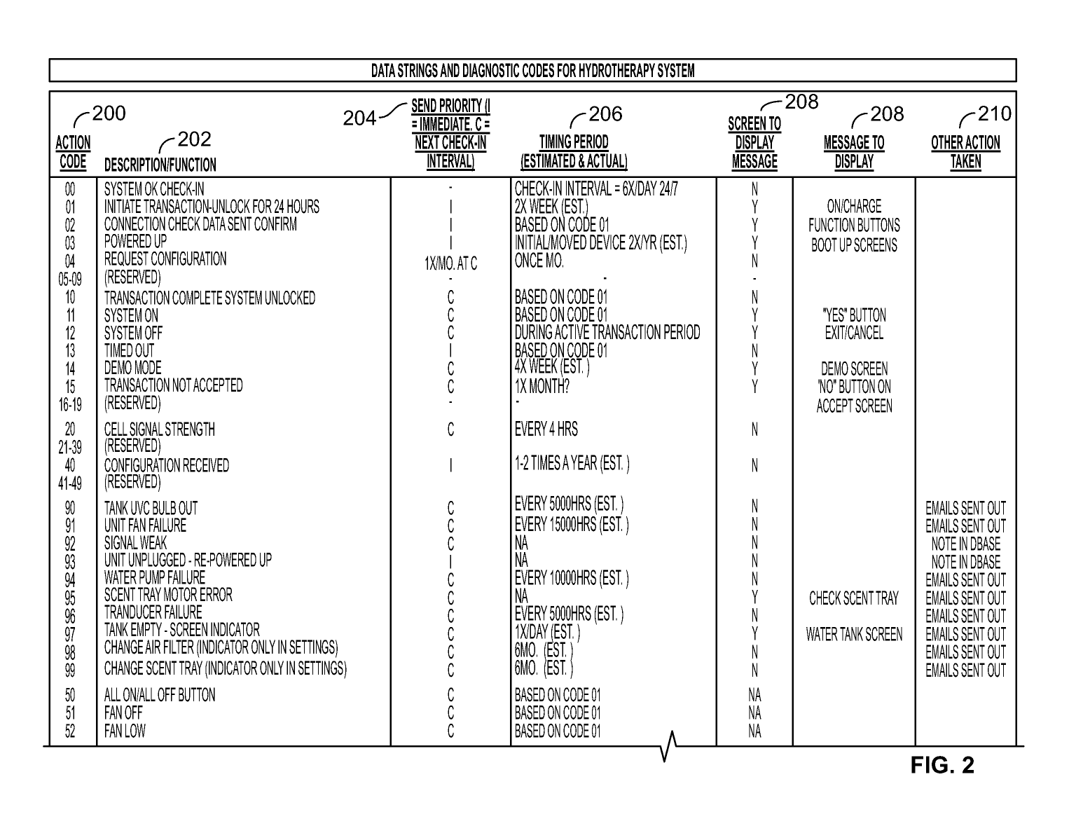

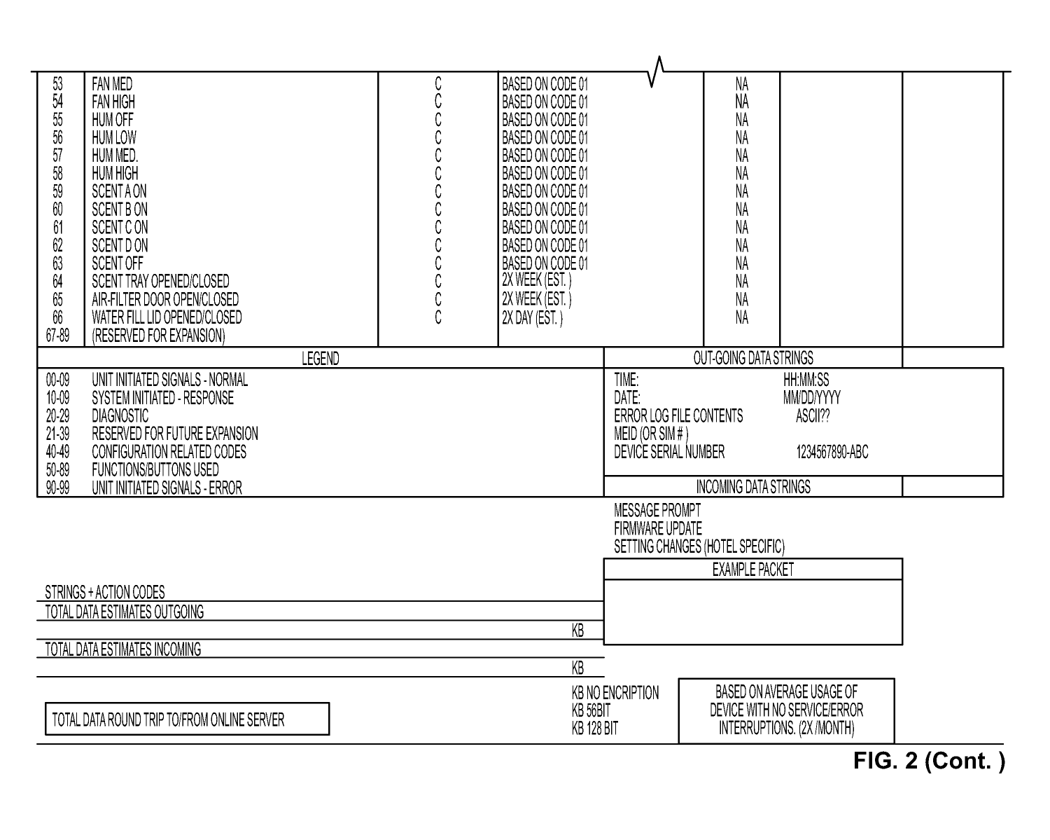

Messages associated with device actions also may be coded to report particular device errors or alerts. For example, device actions may include a diagnostic code associated with a need to replace a consumable (e.g., water or a non-functioning bulb) in an environmental control and monitoring device 110. FIG. 2 is a diagram showing a table of diagnostic codes that may be used for remotely managing an environmental control and monitoring device in accordance with an embodiment. For example, diagnostic (action) codes 200 may be two-digit numerical codes (e.g., 00, 01, 40, etc.) or alpha-numeric strings that can be translated to correspond to a description 202 of a specific error, maintenance or repair request, or other detected event associated with an environmental control and monitoring device 110. In one embodiment, one or more diagnostic codes 200 may be associated with a priority level 204 or an estimated or actual timing period for attention 206. Certain diagnostic codes 200 also may be associated with display requests 208 (e.g., at a web portal interface) or other actions 210 (e.g., email messages, etc.). It should be noted that in certain embodiments, environmental control and monitoring devices 110 may use other schemes for encoding diagnostic codes. For example, four-digit numerical strings may be used for diagnostic codes.

In one embodiment, each occurrence of an event can be associated with an action code. As such, when a device action including an action code is received by environmental control and monitoring device manager 102, the information associated with that action code can be collected, sorted, and analyzed by the environmental control and monitoring device manager 102 to determine a management action.

In certain embodiments, a web portal interface may be provided for administrators to access environmental control and monitoring device manager 102. For example, the web portal interface may display device actions (and associated action codes). The web portal interface also may be capable of organizing and displaying information regarding device actions in various formats. In one embodiment, the web portal interface may be restricted based on an administration status of a user. For example, a user possessing administrator status (e.g., a hotel manager) may be able to view current or previous device actions received from any particular environmental control and monitoring device. However, a user with a more limited administrator status (e.g., a hotel concierge) may only be able to view device actions received from selected environmental control and monitoring device. As such, where the web portal interface may be accessible to different types of users, each type of user may have different levels of access to information as well as ability to view, change, and run functions and view reports online.

In one embodiment, various user roles may include Master Administrators, Billing Administrators, Service Administrators, Hotel Administrators, and Regional Administrators. For example, the web portal interface associated with Master Administrator accounts (e.g., senior management of an entity providing the environmental control and monitoring device manager) may allow users to see all incoming device actions, modify rights and access, run master level reports, and manipulate information as needed for bookkeeping and other functions. Billing Administrators may have access to individual accounts and usable information. Service Administrators may have access to tools to service and update devices as well as to check a status of an error report, and Hotel Administrators may have access to view and run basic reports.

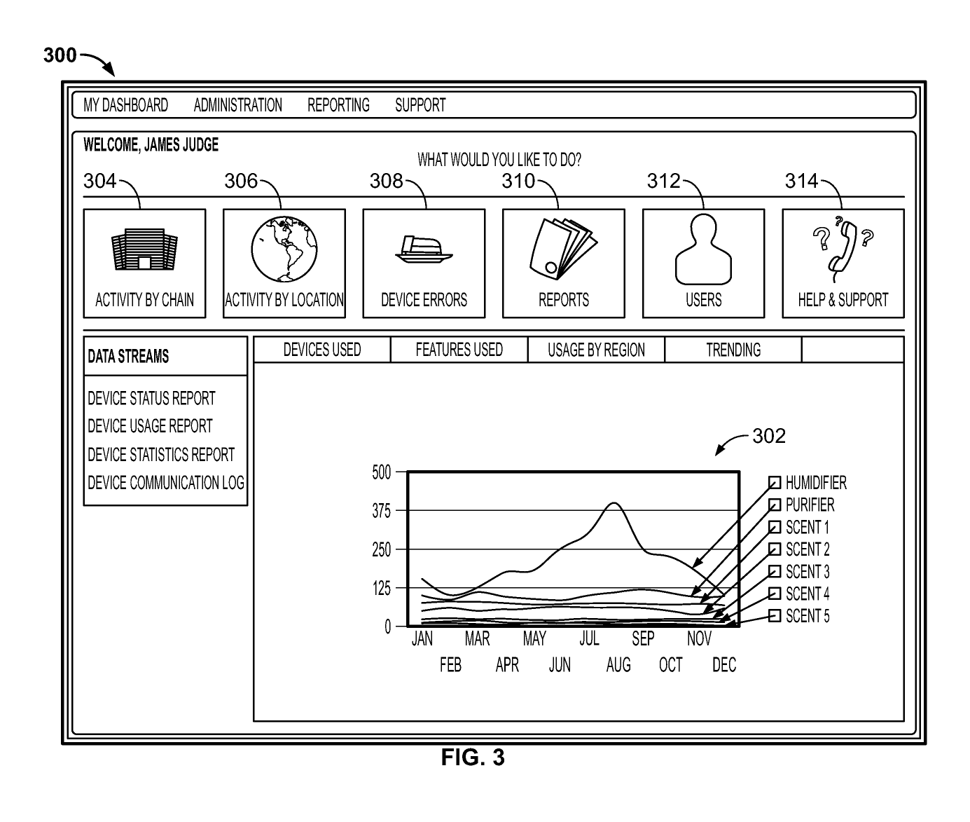

FIG. 3 is a diagram showing a web portal interface display for remotely managing an environmental control and monitoring device in accordance with an embodiment. For example, web portal interface 300 may display a graph 302 showing plots representing one or more usage parameters (e.g., usage of a humidifier, purifier and various diffuser scents) and of one or more environmental control and monitoring devices 110. Web portal interface 300 also includes selector buttons for various alternative arrangements of information, including activity by (hotel) chain 304, activity by location 306 and device errors 308. Additional selector buttons include buttons for obtaining device reports 310, user data 312 and help & support 314.

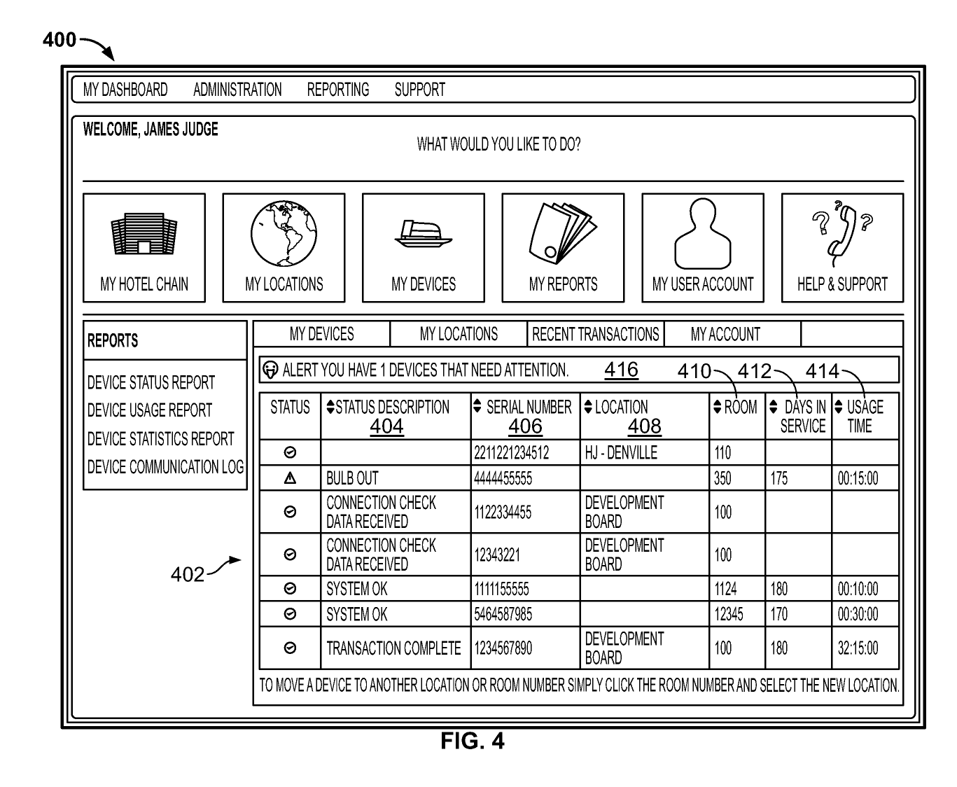

FIG. 4 is another diagram showing a web portal interface display for remotely managing an environmental control and monitoring device in accordance with an embodiment. For example, web portal interface 400 may display a device status report 402 that lists device status descriptions 404 for a particular environmental control and monitoring device 110 by serial number 406, specific location 408, room number 410, days in service 412 and usage time 414. In one embodiment, an alert badge 416 may be displayed to call attention to a particular device action regarding a device.

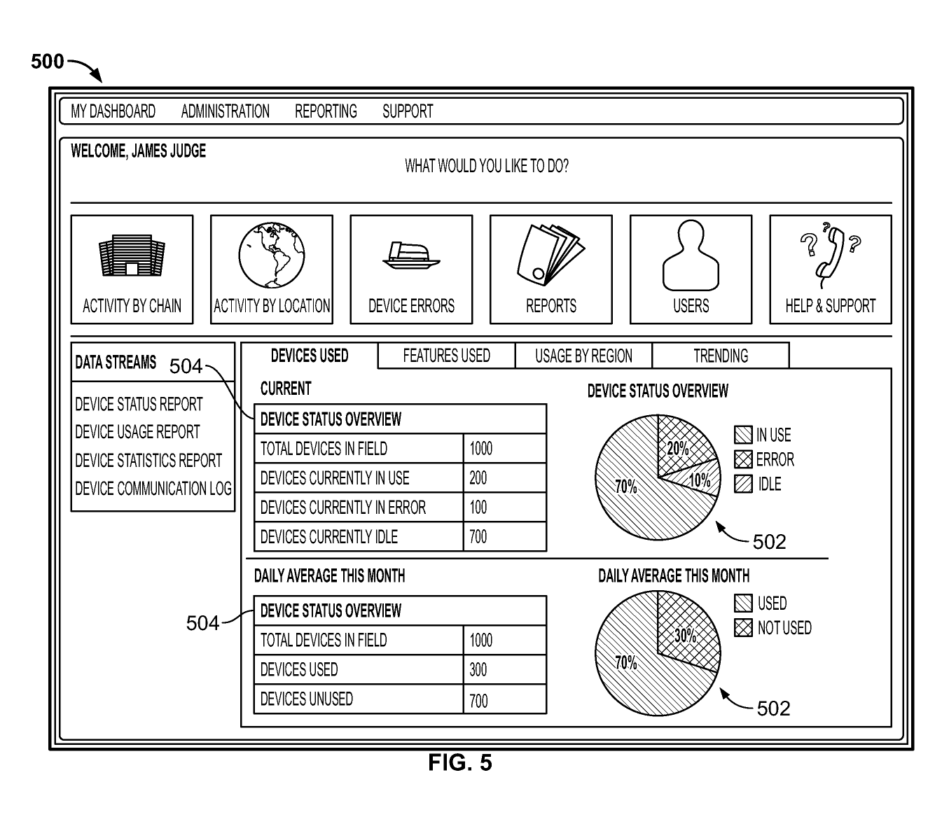

FIG. 5 is another diagram showing a web portal interface display for remotely managing an environmental control and monitoring device in accordance with an embodiment. For example, web portal interface 500 may display one or more pie charts 502 showing device performance and one or more associated usage overviews 504, such as an overview of usage over a selected period of time.

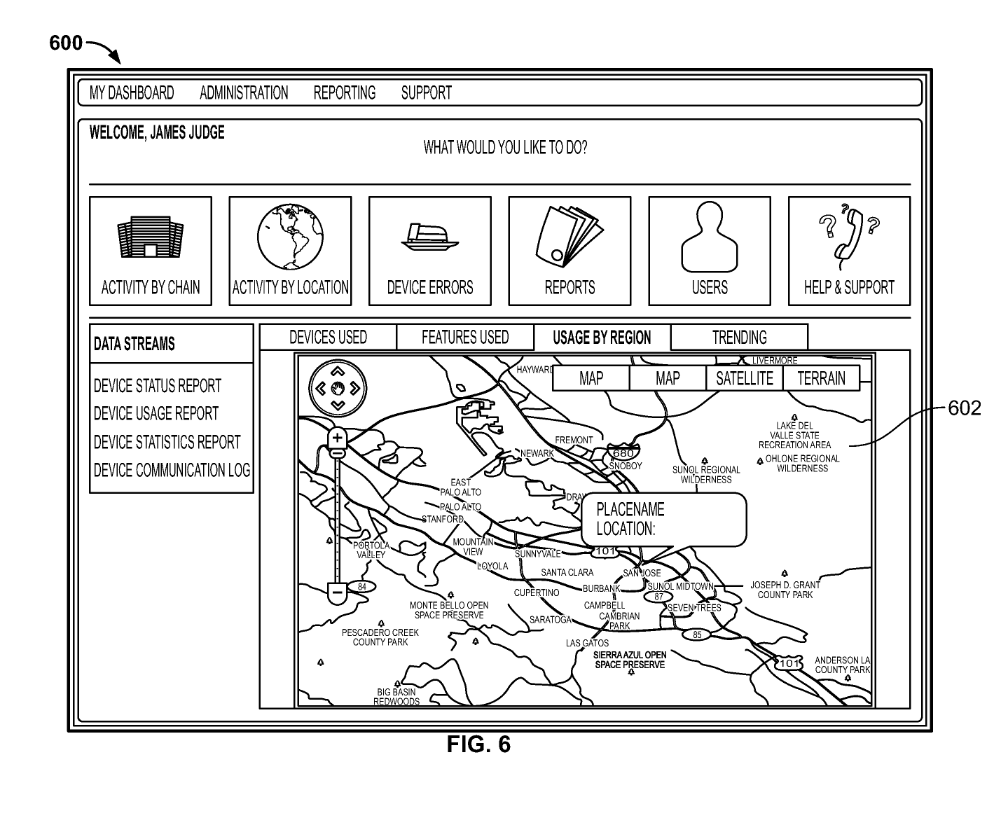

FIG. 6 is another diagram showing a web portal interface display for remotely managing an environmental control and monitoring device in accordance with an embodiment. For example, web portal interface 600 may display a map 602 that indicates the current location of a device, or devices reporting a selected status within a selected region. As such, map 602 may be displayed as a regional map including information such as which devices have the highest and lowest usage (e.g., for marketing purposes). For example, an administrator at web portal interface 600 may select an area of map 602 to update device firmware or settings within the selected area.

In some embodiments, the data stored at database 114 may be collected and sold to parties interested in purchasing it, such as marketing companies or organizations interested in usage data related to the environmental control and monitoring devices. For example, the data collected regarding the use and performance of environmental control and monitoring devices may be analyzed in order to generate information that may be useful to improve future generations or versions of environmental control and monitoring devices. Raw or analyzed data also may be shared with the manufacturers of environmental control and monitoring devices. For example, the data received from devices may be utilized for improving the devices through production cost reduction, reduced time to market and increased profitability. In addition, the data collected from devices may be shared with a third-party (e.g., a hotel) for the third-party's internal use or for use in marketing to their customers.

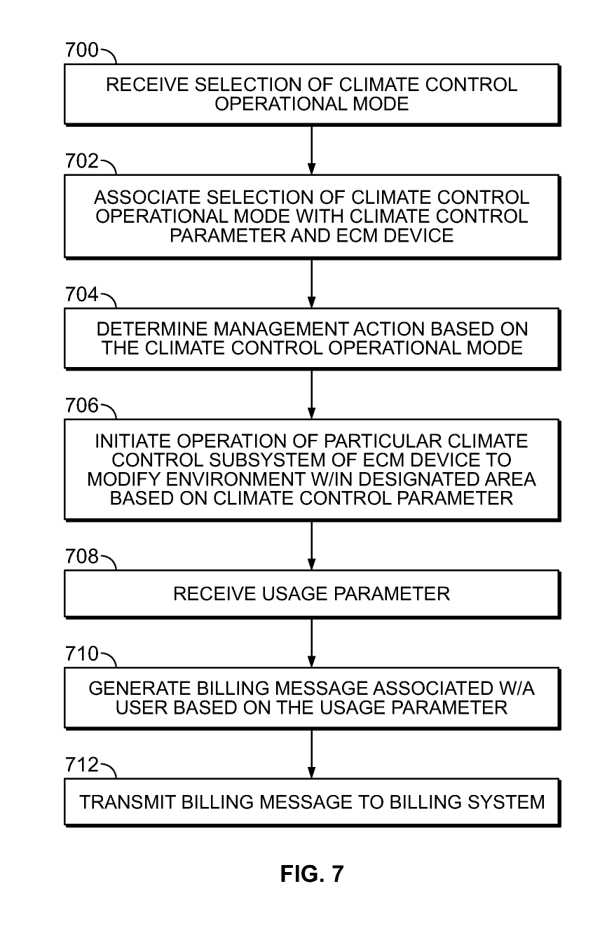

FIG. 7 is a flow diagram for environmental control and monitoring in accordance with an embodiment. Referring back to FIG. 1, an environmental control and monitoring device 110 (e.g., a networked appliance such as a clothes washer, clothes dryer, refrigerator, HVAC unit, air purifier, humidifier or fragrance diffuser) may be in communication with an environmental control and monitoring device manager 102 via network 100. The environmental control and monitoring device 110 may be located at a remote location, such as a hotel room, cruise ship stateroom or office, and may include a networking module 112 or combinations of networking modules (e.g., Wi-Fi, GPS or other similar modules) for communicating device actions via network 100.

The environmental control and monitoring device 110 may transmit data such as status information to environmental control and monitoring device manager 102 periodically. For example, the environmental control and monitoring device 110 may transmit device actions at regular intervals (e.g., 1-24 times per day or more). In addition, the environmental control and monitoring device 110 may transmit one or more device actions associated with a particular occurrence, such as a guest request to use the device (e.g., a selection of a climate control operational mode) or an alert condition of the device, or instantaneously (e.g., without any triggering preconditions).

As such, at 700, environmental control and monitoring device manager 102 receives an electronic communication (e.g., a device action) including a selection of a climate control operational mode to modify an environment within a particular designated area from one of a plurality of environmental control and monitoring devices 110 via network 100. As discussed in regard to FIG. 1 above, each of the plurality of environmental control and monitoring devices 110 may include one or more climate control subsystems for modifying an environment within a designated area, such as at a remote location 104, 106 or 108. The selection of the climate control operational mode also may be received by environmental control and monitoring device manager 102 from a user device or a remote device controller, such as remote controller 118, via network 100. Further, environmental control and monitoring device manager 102 may receive the selection of the climate control operational mode by interfacing with an environmental control and monitoring device 110, such as via a networking module 112.

At 702, environmental control and monitoring device manager 102 associates the selection of the climate control operational mode with a climate control parameter and the one of the plurality of environmental control and monitoring devices 110. For example, environmental control and monitoring device manager 102 may associate the selection of the climate control operational mode with an environmental control and monitoring device 110 by accessing a memory, such as database 114, that provides stored user profiles. Environmental control and monitoring device manager 102 may then associate the selection of the climate control operational mode with a stored user profile from memory, and select a climate control subsystem for activation based on the stored user profile.

In another example, environmental control and monitoring device manager 102 may access a memory, such as database 114, that provides stored records of previously selected climate control operational modes, and select a climate control subsystem for activation based on the previously selected climate control operational modes.

At 704, a management action is determined by the environmental control and monitoring device manager 102 based at least on the received selection of the climate control operational mode. Determining the management action may include determining a command to execute an operation of the environmental control and monitoring device that transmitted the selected climate control operational mode. The management action may include a command to record status information, usage information or other information useful to maintain the proper operation of the environmental control and monitoring device that transmitted the received device action. The management action also may include a command to transmit authorization information, software updates, or other messages to the environmental control and monitoring device. For example, a first management action may activate a charge room code and transmit a command to the hotel's billing system, e.g., billing system 120. Once the billing system 120 has received the charge room code and authorized the charge, the environmental control and monitoring device manager 102 may determine a second management action to unlock the device for use by the guest.

At 706, environmental control and monitoring device manager 102 initiates (e.g., via a transmitted electronic command) an operation of a particular climate control subsystem of the one of the plurality of environmental control and monitoring devices 110 to modify the environment within the particular designated area based on the climate control parameter. The climate control subsystem may modify the environment within a designated area within a designated range based the climate control parameter. For example, the climate control parameter may be a preferred temperature of 75 degrees Fahrenheit and the climate control subsystem may modify the environment within a designated area (e.g., a hotel room) within plus or minus 2 degrees Fahrenheit (i.e., a determined tolerance) based on the 75 degree Fahrenheit climate control parameter.

The environmental control and monitoring device manager 102 also may initiate an interface between the climate control subsystem and an external device to modify the environment within a designated area within a designated range based the climate control parameter. For example, an external device, such as an in-room thermostat, may be responsive to be activated (e.g., wirelessly) by the climate control subsystem of the environmental control and monitoring device 110 based on the climate control parameter to modify the environment within the designated area.

For example, in a hotel environment, environmental control and monitoring device manager 102 may receive a climate control parameter that indicates that a guest wishes to use an environmental control and monitoring device 110. In such case, environmental control and monitoring device manager 102 may initiate an operation of a particular climate control subsystem of the particular environmental control and monitoring device 110 by one or more management actions. In one embodiment, a third-party manager 126 (e.g., a hotel guest management system) may store guest access information to allow, change, or limit a guest's ability to activate an environmental control and monitoring device 110. For example, environmental control and monitoring device manager 102 may receive guest access information from a hotel guest management system (e.g., by transmitting a command as part of a check routine). Environmental control and monitoring device manager 102 may then transmit the guest access information for display at an environmental control and monitoring device 110 (e.g., within a room associated with the guest access information). The environmental control and monitoring device 110 also may be permitted to access, via environmental control and monitoring device manager 102 and network 100, the hotel guest management system for selected guest access information.

At 708, a usage parameter based on the operation of the particular climate control subsystem is received by environmental control and monitoring device manager 102 via the network. The usage parameter may indicate one of a consumable resource level, a filter status or other usage-type information. For example, if the environmental control and monitoring device 110 is a networked appliance such as a humidifier or fragrance diffuser, the usage parameter may indicate the amount of water or fragrance (e.g., perfume) consumed by the networked appliance in operation as a result of its activation by the climate control subsystem for a particular instance.

At 710, a billing message associated with a user is generated by environmental control and monitoring device manager 102 based on the usage parameter. The billing message is transmitted to billing system 120, wherein the billing message results in a charge to an account of the user at 712. For example, the billing message may result in a charge to an account associated with a user profile.

As such, an environmental control and monitoring system is disclosed. The environmental control and monitoring system allows for receiving an electronic communication including a selection of a climate control operational mode to modify an environment within a particular designated area from one of a plurality of environmental control and monitoring devices via a network. The selection of the climate control operational mode can be associated with a climate control parameter and the particular environmental control and monitoring device. An operation of a particular climate control subsystem of the particular environmental control and monitoring device can be initiated to modify the environment within the particular designated area based on the climate control parameter.

Further, environmental control and monitoring system allows for receiving, via the network, a usage parameter based on the operation of the particular climate control subsystem. A billing message associated with a user can be generated based on the usage parameter, and the billing message can be transmitted to a billing system, wherein the billing message results in a charge to an account of the user.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. Certain steps of the methods described herein, including one or more of the steps of FIG. 7, may be performed by a server or by another processor in a network-based cloud-computing system. Certain steps of the methods described herein, including one or more of the steps of FIG. 7, may be performed by a client computer in a network-based cloud computing system. The steps of the methods described herein, including one or more of the steps of FIG. 7, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 7, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

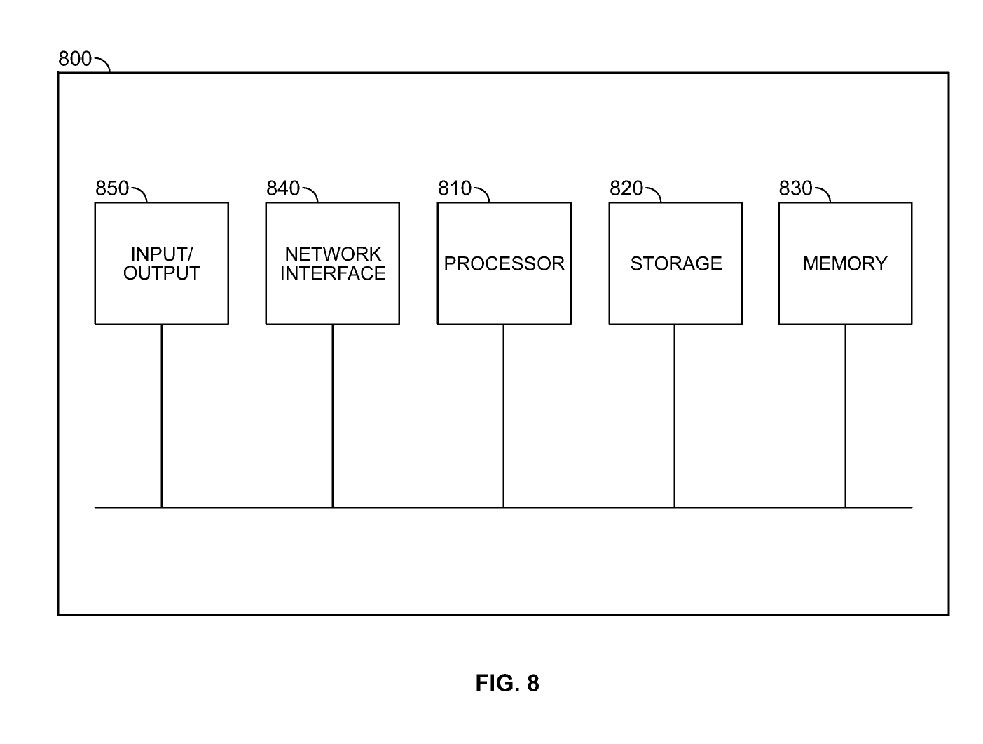

A high-level block diagram of an exemplary computer that may be used to implement systems, apparatus and methods described herein is illustrated in FIG. 8. Computer 800 comprises a processor 810 operatively coupled to a data storage device 820 and a memory 830. Processor 810 controls the overall operation of computer 800 by executing computer program instructions that define such operations. The computer program instructions may be stored in data storage device 820, or other computer readable medium, and loaded into memory 830 when execution of the computer program instructions is desired. Thus, the method steps of FIG. 7 can be defined by the computer program instructions stored in memory 830 and/or data storage device 820 and controlled by processor 810 executing the computer program instructions. For example, the computer program instructions can be implemented as computer executable code programmed by one skilled in the art to perform an algorithm defined by the method steps of FIG. 7. Accordingly, by executing the computer program instructions, the processor 810 executes an algorithm defined by the method steps of FIG. 7. Computer 800 also includes one or more network interfaces 840 for communicating with other devices via a network. Computer 800 also includes one or more input/output devices 850 that enable user interaction with computer 800 (e.g., display, keyboard, mouse, speakers, buttons, etc.).

Processor 810 may include both general and special purpose microprocessors, and may be the sole processor or one of multiple processors of computer 800. Processor 810 may comprise one or more central processing units (CPUs), for example. Processor 810, data storage device 820, and/or memory 830 may include, be supplemented by, or incorporated in, one or more application-specific integrated circuits (ASICs) and/or one or more field programmable gate arrays (FPGAs).

Data storage device 820 and memory 830 each comprise a tangible non-transitory computer readable storage medium. Data storage device 820, and memory 830, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 850 may include peripherals, such as a printer, scanner, display screen, etc. For example, input/output devices 850 may include a display device such as a cathode ray tube (CRT), plasma or liquid crystal display (LCD) monitor for displaying information to the user, a keyboard, and a pointing device such as a mouse or a trackball by which the user can provide input to computer 800.

Any or all of the systems and apparatus discussed herein, including environmental control and monitoring device manager 102 and database 114 may be implemented using a computer such as computer 800. One skilled in the art will note that environmental control and monitoring device manager 102 may be implemented using standard technologies, including software, hardware, firmware or any combination thereof.

One skilled in the art also will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. An environmental control and monitoring system comprising:
a plurality of environmental control and monitoring devices at one or more remote locations, each of the plurality of environmental control and monitoring devices including one or more climate control subsystems for modifying an environment within a designated area;
a billing system; and
an environmental control and monitoring device manager which, in electronic communication with the plurality of environmental control and monitoring devices, is adapted to:
receive, via a network, a selection of a climate control operational mode to modify an environment within a particular designated area;
associate the selection of the climate control operational mode with a climate control parameter and a particular environmental control and monitoring device of the plurality of environmental control and monitoring devices;
initiate an operation of a particular climate control subsystem of the particular environmental control and monitoring device to modify the environment within the particular designated area based on the climate control parameter;
receive, via the network, a usage parameter based on the operation of the particular climate control subsystem;
generate a billing message associated with a user based on the usage parameter; and
transmit the billing message to the billing system, wherein the billing message results in a charge to an account of the user.

2. The system of claim 1, wherein the selection of the climate control operational mode is received from one of a user device or a remote device controller via the network.

3. The system of claim 1, wherein the environmental control and monitoring device manager is further adapted to interface with a networked appliance to receive the selection of the climate control operational mode.

4. The system of claim 3, wherein the networked appliance includes one of a clothes washer, clothes dryer, refrigerator, HVAC unit, air purifier, humidifier or fragrance diffuser.

5. The system of claim 3, wherein the networked appliance is located in one of a hotel room, cruise ship stateroom or office.

6. The system of claim 1, wherein the environmental control and monitoring device manager is further adapted to:
access a memory providing stored user profiles;
associate the selection of the climate control operational mode with a stored user profile; and
select the climate control subsystem for activation based on the stored user profile.

7. The system of claim 1, wherein the environmental control and monitoring device manager is further adapted to:
access a memory providing one or more records of previously selected climate control operational modes; and
select the climate control subsystem for activation based on one of the previously selected climate control operational modes.

8. The system of claim 1, wherein the climate control subsystem modifies the environment within the designated area within a designated range based the climate control parameter.

9. The system of claim 1, wherein the environmental control and monitoring device manager is further adapted to initiate an interface between the climate control subsystem and an external device, the external device operable to be activated based on the climate control parameter to modify the environment within the designated area.

10. The system of claim 1, wherein the usage parameter indicates one of a consumable resource level or a filter status.

11. A method for environmental control and monitoring, the method comprising:
receiving, from one of a plurality of environmental control and monitoring devices via a network, an electronic communication including a selection of a climate control operational mode to modify an environment within a particular designated area, wherein each of the plurality of environmental control and monitoring devices include one or more climate control subsystems for modifying an environment within a designated area;
associating the selection of the climate control operational mode with a climate control parameter and the one of the plurality of environmental control and monitoring devices;
initiating an operation of a particular climate control subsystem of the one of the plurality of environmental control and monitoring devices to modify the environment within the particular designated area based on the climate control parameter;
receiving, via the network, a usage parameter based on the operation of the particular climate control subsystem;
generating a billing message associated with a user based on the usage parameter; and
transmitting the billing message to a billing system, wherein the billing message results in a charge to an account of the user.

12. The method of claim 11, wherein the selection of the climate control operational mode is received from one of a user device or a remote device controller via the network.

13. The method of claim 11, wherein the selection of the climate control operational mode is received from a networked appliance.

14. The method of claim 13, wherein the networked appliance includes one of a clothes washer, clothes dryer, refrigerator, HVAC unit, air purifier, humidifier or fragrance diffuser.

15. The method of claim 13, wherein the networked appliance is located in one of a hotel room, cruise ship stateroom or office.

16. The method of claim 11, further comprising:
accessing a memory providing stored user profiles;
associating the selection of the climate control operational mode with a stored user profile; and
selecting the climate control subsystem for activation based on the stored user profile.

17. The method of claim 11, further comprising:
accessing a memory providing one or more records of previously selected climate control operational modes; and
selecting the climate control subsystem for activation based on one of the previously selected climate control operational modes.

18. The method of claim 11, wherein the climate control subsystem modifies the environment within the designated area within a designated range based the climate control parameter.

19. The method of claim 11, wherein the environmental control and monitoring device manager is further adapted to initiate an interface between the climate control subsystem and an external device, the external device operable to be activated based on the climate control parameter to modify the environment within the designated area.

20. The method of claim 11, wherein the usage parameter indicates one of a consumable resource level or a filter status.
